(19) United States
(12) Patent Application Publication
(10) Pub. No.: US 2018/0084392 A1
(43) Pub. Date: Mar. 22, 2018

(54) TEXT MESSAGING HUB SYSTEM PROVIDING ACCESS TO LOCAL AND REMOTE SERVICE APPLICATIONS

(71) Applicant: eBay Inc., San Jose, CA (US)

(72) Inventors: Ehsan Razfar, San Jose, CA (US); Ethan Rubinson, Santa Clara, CA (US); Aaron Tainter, Santa Clara, CA (US)

(21) Appl. No.: 15/269,392

(22) Filed: Sep. 19, 2016

(51) Int. Cl. H04W 4/14; H04L 12/58; H04L 29/08

(52) U.S. Cl. CPC H04W 4/14; H04L 51/10; H04L 69/329; H04L 67/327; H04L 67/025

(57) ABSTRACT

Example embodiments provide a system and a method for a multi-service hub to respond to a service application request in a text message received from a. cellular device. The multi-service hub determines whether the service application request is a local service application request or remote service application request. A local service application request is processed with a local service application at the multi-service hub. A remote service application request is forwarded from the multi-service hub to a remote service application handler.

### TECHNICAL FIELD

Embodiments of the present disclosure relate generally to accessing local network service applications via text message.

### BACKGROUND

Present techniques access remote network application services via text message from a cellular device but lack access to local network service applications. Such techniques forward all service application requests to remote Internet servers. Present techniques rely on remote Internet application services that either cannot support local services or have only spotty geographic support. This results in a lack of localized service applications for the user of the cellular device. It is within this context that the present disclosure arises.

### BRIEF DESCRIPTION OF THE DRAWINGS

Various ones of the appended drawings merely illustrate example embodiments of the present disclosure and cannot be considered as limiting its scope.

FIG. 1 is a network diagram illustrating a network service application environment suitable for a multi-service hub that provides text message-based access to local and remote network service applications, according to some example embodiments.

FIG. 2 is a bounce diagram illustrating an example sequence of messages and processes to access remote network service applications in the network service application environment, according to some example embodiments.

FIG. 3 is a bounce diagram illustrating an example sequence of messages and processes to access local network service applications in the network service application environment, according to some example embodiments.

FIG. 4 is a block diagram illustrating components of a multi-service hub according to some example embodiments.

FIG. 5 is a network diagram illustrating a remote portion of a network service application environment suitable for a multi-service hub that provides text message-based access to local and remote network service applications, according to some example embodiments.

FIG. 6 is a network diagram illustrating a network service application environment suitable for configuration of a multi-service hub that provides text message-based access to local and remote network service applications, according to some example embodiments.

FIG. 7 is a block diagram illustrating an example of a software architecture that may be installed on a machine, according to some example embodiments.

The headings provided herein are merely for convenience and do not necessarily affect the scope or meaning of the terms used.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. In general, well-known instruction instances, protocols, structures, and techniques have not been shown in detail. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

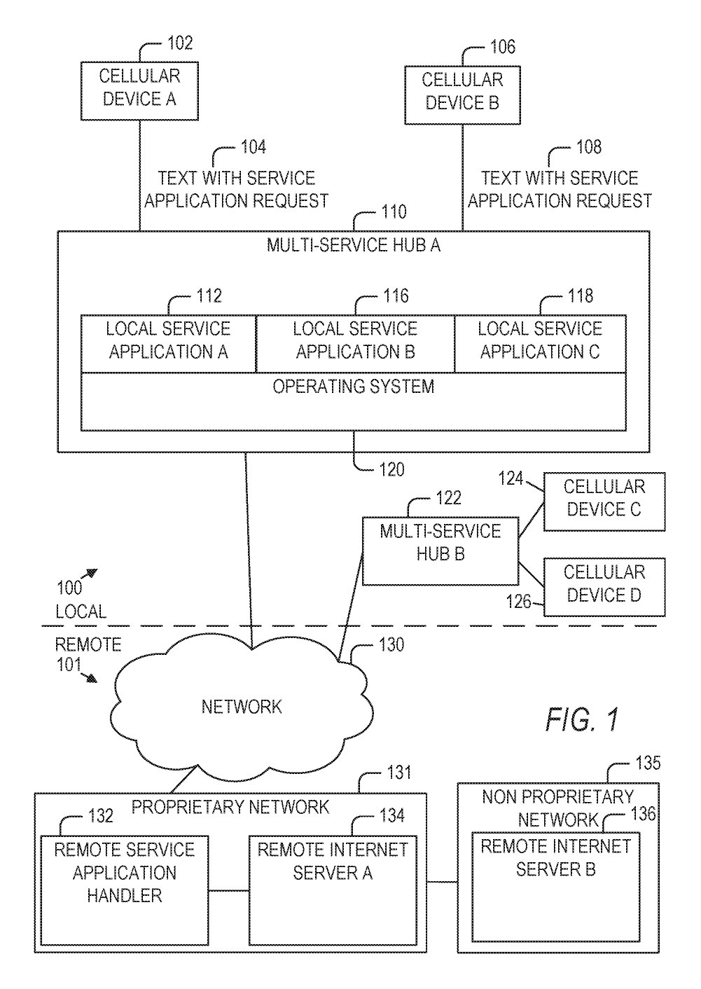

FIG. 1 is a network diagram illustrating a network service application environment suitable for a multi-service hub that provides text message-based access to local and remote network service applications, according to some example embodiments. The network service application environment is divided, as indicated by the dashed line, into a local network service application environment 100 and a remote network service application environment 101. The cellular device A 102 and the cellular device B 106 are coupled via respective cellular connections to the multi-service hub A 110 that processes service application requests from the cellular device A 102 and the cellular device B 106. The cellular device C 124 and the cellular device D 126 are coupled via respective cellular connections to the multi-service hub B 122 that processes service application requests from the cellular device C 124 and the cellular device D 126.

The multi-service hub A 110 the multi-service hub B 122 are communicatively coupled via a network 130 to remote service application handler 132 to access remote network service applications to process service application requests from the cellular device A 102, the cellular device B 106, the cellular device C 124, and the cellular device D 126. The remote service application handler 132 is communicatively coupled to remote Internet server A 134 in a proprietary network. The remote service application handler 132 is communicatively coupled to remote Internet server B 136 via the network 130. Remote Internet server A 134 and remote Internet server B 136 support one or more remote service applications.

The cellular device A 102, the cellular device B 106, the cellular device C 124, and the cellular device 126 each comprises, in various embodiments, a basic cellular phone, a smartphone, a tablet, a laptop, a multi-processor system, microprocessor-based or programmable consumer electronics, a. game console, a set-top box, or any other device that a user utilizes to communicate over a cellular connection. One or more portions of the cellular connection, in various embodiments, comprises AMPS, TACS, NMT, GSM, D-AMPS, IS-95, GPRS, IMT-2000, CDMA 2000, RTT, EV-DO, UMTS, EDGE, HSPA+, IMT-Advanced, WiMAX, WIMAX 2, LTE, LTE-Advanced, standard revisions, another type of cellular network connection, or a combination of two or more such networks connections. The cellular device A 102, the cellular device B 106, the cellular device C 124, and the cellular device D 126 send and receive text messages compliant with the Short Message Service (SMS), multimedia messages (MMS), or other text message protocol.

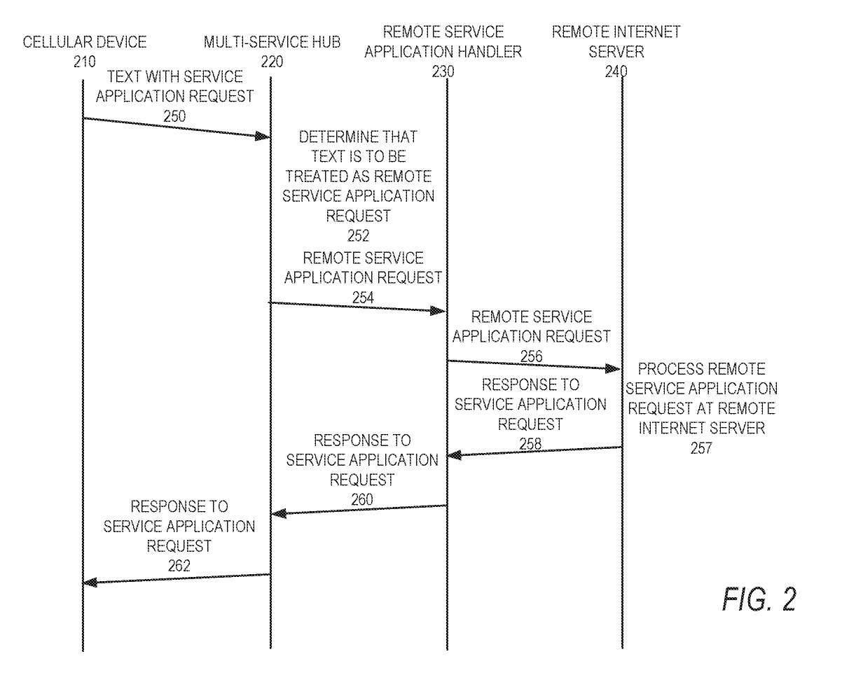

The multi-service hub A 110 is configured to determine whether the text messages received from, respectively, the cellular device A 102 and the cellular device B 106, are to be treated as service application requests. Responsive to a service application request that is determined by the multi-service hub to be treated as a remote service application request, the multi-service hub A 110 forwards the remote service application request to remote service application handler 132. Responsive to a service application request that is determined by the multi-service hub to be treated as a local service application request, the multi-service hub A 110 processes the local service application request at the multi-service hub A 110. For example, various local service application requests are processed by local service application A 112, local service application B 116, and local service application C 118 that are in an application layer above an operating system layer 120. An example of a multi-service hub is discussed in connection with FIGS. 2-4 and 6. The multi-service hub B 122 is similarly configured to process text messages from the cellular device C 124 and the cellular device D 126.

One or more portions of network 130, in various embodiments, comprises an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The remote service application handler 132 is configured to forward remote service application requests from the multi-service hub to an appropriate remote Internet server for additional processing and to be directed to the correct remote service application. Also, the remote service application handler 132 is configured to forward responses to service application requests back to the multi-service hub. The remote service application handler 132 accesses a node registry to track different instances of the multi-service hubs. The remote service application handler 132 also accesses a service registry to track whether a particular service application is remote proprietary, remote third party or local.

The remote Internet server A 134 and remote Internet server B 136 process remote service application requests, and return responses to service application requests. Example remote service applications are search, information retrieval, storage, inquiries for tangible goods or intangible goods, inquiries for services, and data processing. In some embodiments responses to more common remote service application requests are cached such that the remote service application requests do not have to be processed by a remote Internet server. For example, common responses may be cached at a multi-service hub or proximate to the remote service application handler.

FIG. 2 is a bounce diagram illustrating an example sequence of messages and processes to access remote network service applications in the network service application environment, according to some example embodiments. Messages are passed among a cellular device 210, a multi-service hub 220, a remote service application handler 230, and a remote Internet server 240.

The cellular device 210 sends a text message with a service application request 250 to the multi-service hub 220. At 252, the multi-service hub 220 determines that the text message is treated as a remote service application request 254. As a result of this determination, the service application request is not processed locally at the multi-service hub 220. Local service application requests are processed by local service applications at the multi-service hub 220.

Instead, the multi-service hub 220 sends the remote service application request to the remote service application handler 230. The remote service application handler 230 sends the remote service application request 256 to a remote Internet server 240. Remote service application requests are processed by remote service applications after the remote service application request is forwarded from the multi-service hub 220. In some embodiments the remote service application handler 230 reformats the remote service application request into another protocol to be processed by the remote Internet server 240. In some embodiments the remote service application handler 230 determines whether the remote service application request 256 is sent to a remote Internet server that is within a proprietary network, to a remote :Internet server accessible via the public Internet, or a third party server abiding by a proprietary protocol.

The remote service application handler 230 reformats the remote service request into a consumable data format that includes information sufficient to process the remote service application request at the remote Internet server 240. For example, if the remote service application request received was “WIKI New York Yankees”, this message may be reformatted into JavaScript Object Notation (JSON) and passed to a remote Internet server for processing.

{
“app” : “WIKI”,
“data” : “New York Yankees”,
“originating_number” : 9082166280,
“originating_hub” : 72345
}

Other embodiments are directed to another standard that pairs human-readable text with data objects. In some embodiments similar reformatting for messages occur at the multi-service hub for local service application requests.

In some embodiments a local or remote service application request includes more information used for tracking, authentication, etc. Example protocols include TCP/IP/Webhooks.

At 257 the remote Internet server 240 processes the remote service application request. The remote Internet server 240 contains one or more remote service applications. In some embodiments the remote Internet server 240 forwards the remote Internet server to additional servers for further processing. After the remote service application request is processed, at 258 the remote Internet server 240 sends the response to the remote service application request to the remote service application handler 230. In embodiments where the remote Internet server 240 forwards the remote Internet server to one or more additional servers for further processing, the one or more additional servers optionally send the response to the remote service application request to the remote service application handler 230. Subsequently, at 260 the remote service application handler 230 sends the response to the remote service application request to the multi-service hub 220. In some embodiments the remote service application handler reformats response to the remote service application request between protocols to be processed by the multi-service hub 220. Then, at 262 the multi-service hub 220 sends the response to the remote service application request to the cellular device 210.

The remote service application handler 230 reformats the response to the remote service request in a converse process otherwise similar to reformatting the remote service request. The response includes data gathered by the remote service application.

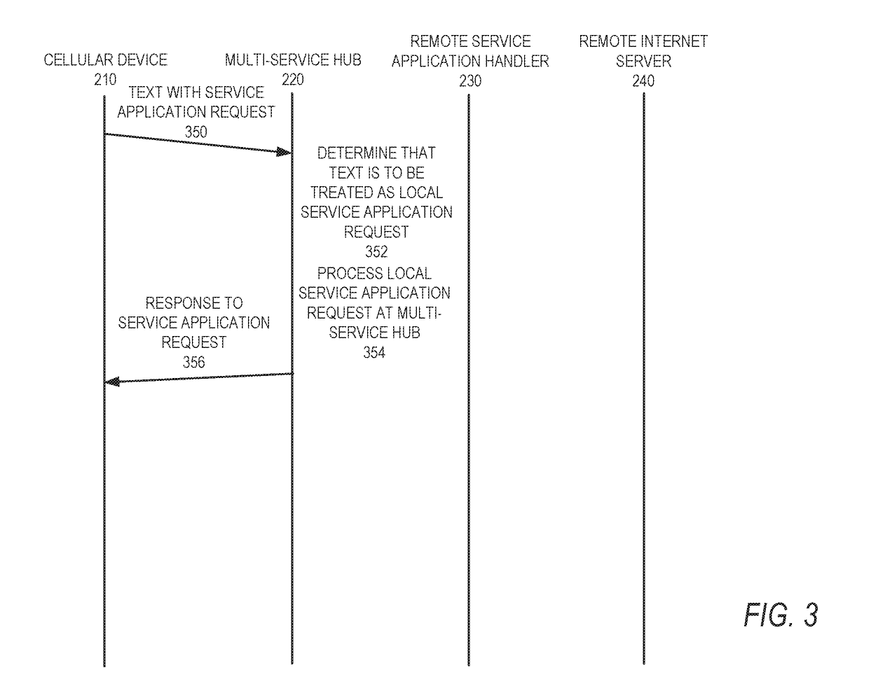

FIG. 3 is a bounce diagram illustrating an example sequence of messages and processes to access local service applications in the network service application environment, according to some example embodiments. Messages are passed among the cellular device 210 and the multi-service hub 220.

The cellular device 210 sends a text message with a service application request 350 to the multi-service hub 220. At 352, the multi-service hub 220 determines that the text message is to be treated as a local service application request 354. As a result of this determination, at 354 the service application request is processed locally at the multi-service hub 220. Then, at 356 the multi-service hub 220 sends the response to the service application request to the cellular device 210.

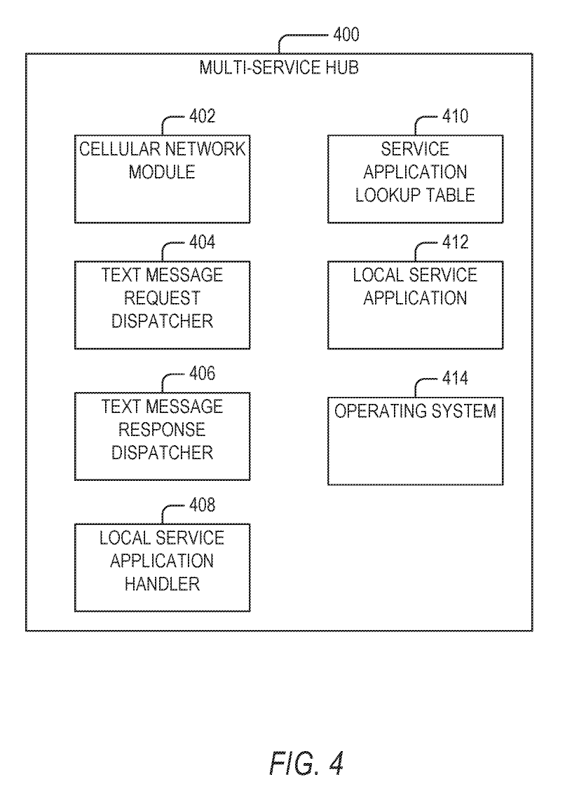

FIG. 4 is a block diagram illustrating components of a multi-service hub according to some example embodiments. Examples of the multi-service hub are Raspberry Pi, Arduino, C.H.I.P., Banana Pi, NanoPi, NanoPC, Parallella, cloudBit, PixelPro, or other computing device, and are discussed in connection with FIGS. 1-3 and 6. The multi-service hub 400 comprises a cellular network module 402, a text message dispatcher 404, a text message response dispatcher 406, a local service application handler 408, a service application lookup table 410, local service applications 412, and an operating system 414.

The cellular network module 402 includes an antenna, a SIM card or equivalent, and cellular telephony hardware and software. The cellular network module 402 allows the multi-service hub 400 to send and/or receive text messages with cellular devices.

The text message request dispatcher 404 receives text messages from the cellular network module 402. The text message is parsed for service application requests. Based on whether the service request is satisfied by a local service application or a remote service application, the service application request is processed at the multi-service hub 400 or forwarded to the remote service application handler.

In one embodiment, parsing searches for one or more substrings in the message that identify the service application.

In another embodiment, artificial intelligence such as a bot attempts to determine the service application that should be used to process the request out of the context of the message.

The text message response dispatcher 406 receives responses to service application requests from local service applications 412 on the multi-service hub 400 and from the remote service application handler. The text message response dispatcher 406 forwards the responses to the cellular network module 406 for communication to one or more cellular devices.

The service application lookup table 410 lists local service application in a local service application registry. In one example, the local service applications are compliant with the service application API or other framework to deliver IP multimedia services. In some embodiments, the service application lookup table 410 also lists remote service applications for remote service application requests that are processed by remote Internet servers. The service application lookup table 410 determines whether a given service application request from a text message is treated as a local service application request processed at the multi-service hub 400 or a remote service application request forwarded from the multi-service hub 400 for processing. In some embodiments, the service application lookup table 410 varies among different multi-service hubs. In one example, the same text message sent to different multi-service hubs results in the same text message being treated as a local service application request at one multi-service hub and as a remote service application request at another multi-service hub.

In one embodiment the service lookup table holds a collection of services configured on the multi-service hub indexed by a key that is unique for every service application. If a requested service application is remote or unknown by the multi-service hub, the request is forwarded on to the remote Internet server for processing. Additionally, in some embodiments each service application entry in the table has one or more other fields such as those to enable/disable the service application (feature toggles). If the service application exists in the table, but is disabled for that user group, the request is not processed by the multi-service hub.

The service application that should be used to process a service application request, is identified by looking up the unique identifying key of that service application which is parsed from the request

Examples of local service applications 412 are a local bazaar targeted to users geographically proximate to the multi-service hub 400, geolocated service applications, a menu of available languages, job listings, want ads, primary care information, a menu of local service applications, a menu of remote service applications, a menu of both local and remote service applications, and a registry of local multi-service hubs including those multi-service hubs that are proximate to the cellular device.

Examples of operating systems 414 are Raspbian, OSMC, OpenELEC, Windows IoT Core, RISC OS, or other computing device OS. The operating system 414 manages computer hardware and software resources and provides common services for the local service applications.

Any one or more of the components (e.g., modules, engines) described herein may be implemented using hardware alone (e.g., one or more processors of a machine) or a combination of hardware and software. For example, any component described herein may physically include an arrangement of one or more of the processors or configure a processor (e.g., among one or more processors of a machine) to perform the operations described herein for that module. Accordingly, different components described herein may include and configure different arrangements of the processors at different points in time or a single arrangement of the processors at different points in time. Each component described herein is an example of a means for performing the operations described herein for that component. Moreover, any two or more of these components may be combined into a single component, and the functions described herein for a single component may be subdivided among multiple components or other components. Furthermore, according to various example embodiments, components described herein as being implemented within a single machine, database, or device may be distributed across multiple machines, databases, or devices, or be located elsewhere in the network service application environment.

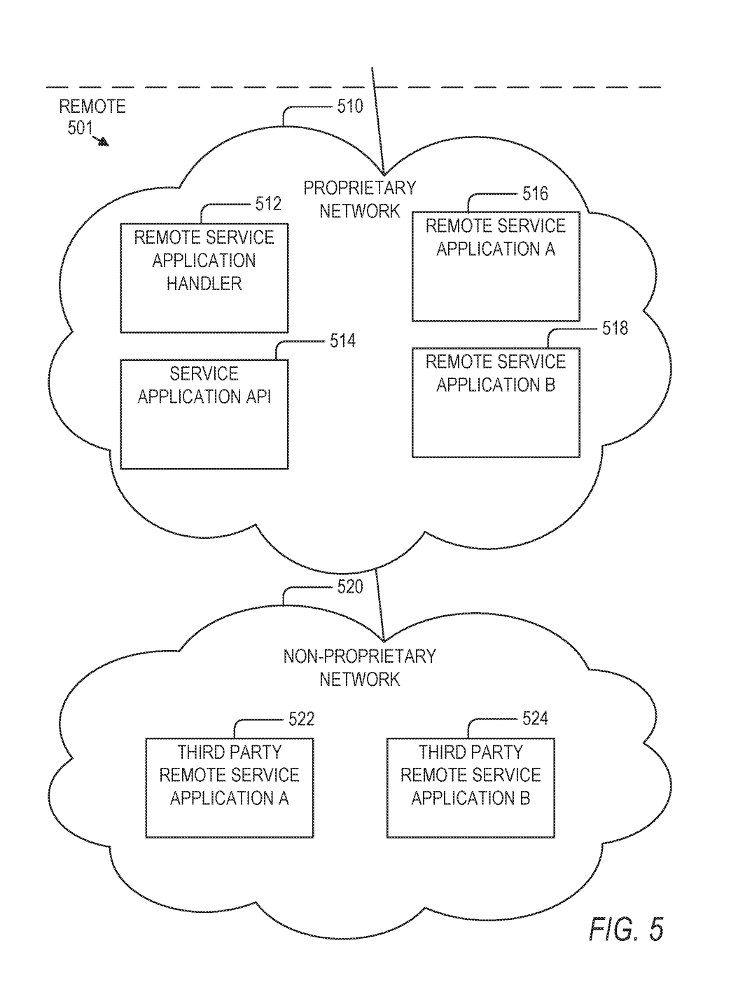

FIG. 5 is a network diagram illustrating a remote portion of a network service application environment suitable for a multi-service hub that provides text message-based access to local and remote network service applications, according to some example embodiments. The remote portion of the network service application environment 501 includes a proprietary network 510 and a non-proprietary network 520.

The proprietary network 510 includes a remote service application handler 512, a remote Internet service application API 514, a remote Internet service A 516, and a remote Internet service application B 518. The non-proprietary network 520 includes a third party remote service application A 522 and a third party remote Internet service application B 524.

The remote service application handler 512 receives remote service application requests from the multi-service hub and forwards the remote service application requests to a remote service API. The remote service application handler 512 also receives responses to remote service application requests from the remote Internet service application and forwards the responses to remote service application requests to a multi-service hub. In some embodiments the remote service application handler reformats the remote service application request into another protocol to be processed by the remote Internet server.

The remote Internet service application API 514 is a set of subroutines and protocols to ensure that the service application request is compatible with remote Internet service applications. The remote Internet service applications A 516 and B 518 are proprietary and serviceable within the proprietary network 510. The third party remote Internet service applications 522 and 524 are accessible via an Internet communication protocol such as TCP/IP webhooks through the remote Internet service API 514.

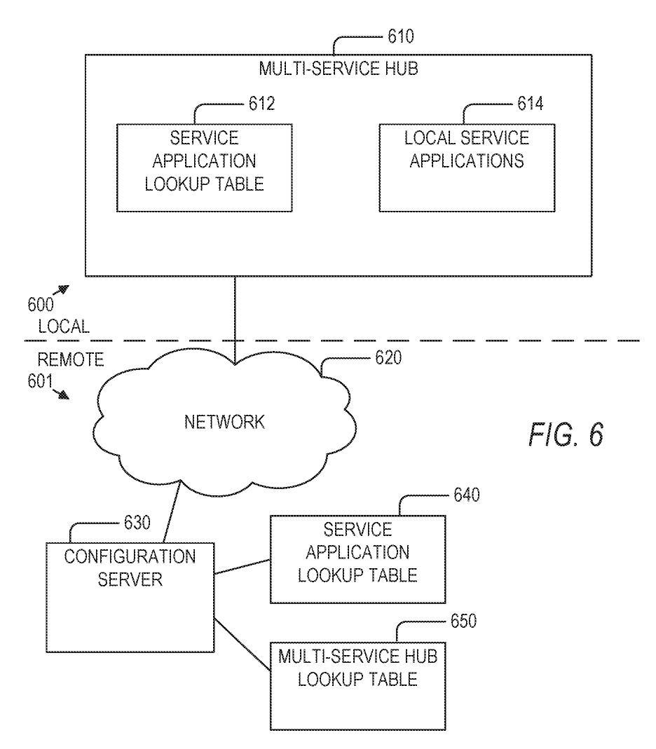

FIG. 6 is a network diagram illustrating a network service application environment suitable for configuration of a multi-service hub that provides text message-based access to local and remote network service applications, according to some example embodiments. The network service application environment is divided, as indicated by the dashed line, into a local network service application environment 600 and a remote network service application environment 601. The local network service application environment 600 includes a multi-service hub 610 with a service application lookup table 612 and local service applications 614. Examples of the multi-service hub 610 are discussed in connection with FIGS. 1-4. The remote network service application environment 601 includes a configuration server 630 communicatively coupled to the multi-service hub 610 via a network 620. The configuration server is communicatively coupled to a service application lookup table 640 and a multi-service hub lookup table 650.

The configuration server 630 updates the service application lookup table 612 and the local service applications 614 in response to a configuration update from the multi-service hub 610. The configuration server 630 pushes new local service applications, updates existing local service applications, and deletes old local service applications. An alternative to pushing local service applications is to activate local service applications that are stored already on the multi-service hub 610 but not accessible to local service application requests until a configuration update. The configuration server 630 also updates the service application lookup table to reflect updates to the local service applications 614. In some embodiments, the configuration server 630 also updates the service application lookup table on the multi-service hub to reflect updates to the remote Internet service applications, to add, modify, or delete remote Internet service applications that are responsive to remote service application requests. In one example, the same text message sent to the same multi-service hub at different times results in the same text message being treated as a local service application request at one time and as a remote service application request at another time.

### Example Machine Architecture and Machine-Readable Medium

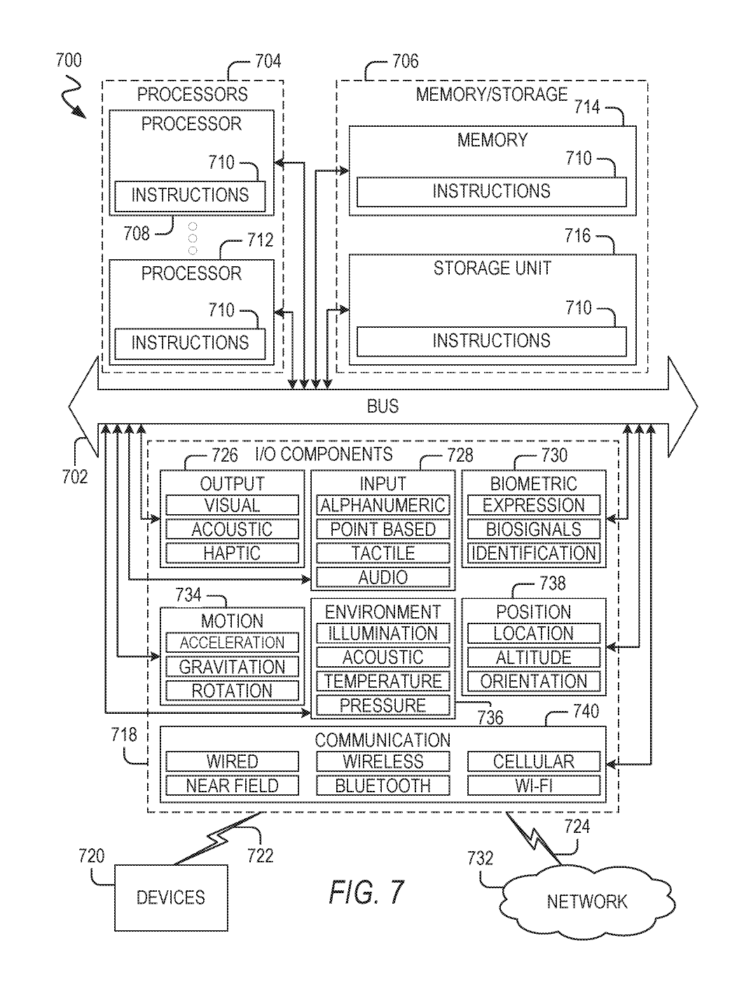

FIG. 7 is a block diagram illustrating components of a machine 700, according to some example embodiments, able to read instructions from a machine-readable medium (e,g., a machine-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. For example, the instructions 710 may cause the machine 700 to execute the bounce diagrams of FIGS. 2-3. Additionally, or alternatively, the instructions 710 may implement the servers associated with the services and components of FIGS. 1-6, and so forth. The instructions 710 transform the general, non-programmed machine 700 into a particular machine 700 programmed to carry out the described and illustrated functions in the manner described.

In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a switch, a controller, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 710, sequentially or otherwise, that specify actions to be taken by the machine 700. Further, while only a single machine 700 is illustrated, the term “machine” shall also be taken to include a collection of machines 700 that individually or jointly execute the instructions 710 to perform any one or more of the methodologies discussed herein.

The machine 700 may include processors 704, memory/storage 706, and I/O components 718, which may be configured to communicate with each other such as via a bus 702. In an example embodiment, the processors 704 (e.g., a Central Processing Unit (CPU), a Reduced instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 708 and a processor 712 that may execute the instructions 710. The term “processor” is intended to include multi-core processors that may comprise two or more independent processors (sometimes referred to as “cores”) that may execute instructions contemporaneously. Although FIG, 7 shows multiple processors 704, the machine 700 may include a single processor with a single core, a single processor with multiple cores (e.g., a multi-core processor), multiple processors with a single core, multiple processors with multiples cores, or any combination thereof.

The memory/storage 706 may include a memory 714, such as a main memory, or other memory storage, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof during execution thereof by the machine 700. Accordingly, the memory 714, the storage unit 716, and the memory of the processors 704 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 710. The term “machine-readable medium” shall also be taken to include any medium, or combination of multiple media, that is capable of storing instructions (e.g., instructions 710) for execution by a machine (e.g., machine 700), such that the instructions, when executed by one or more processors of the machine (e.g., processors 704), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 718 may include a wide variety of components to receive input, provide output, produce output, transmit information, exchange information, capture measurements, and so on. The specific I/O components 718 that are included in a particular machine will depend on the type of machine. For example, portable machines such as mobile phones will likely include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion, and the grouping is in no way limiting. In various example embodiments, the I/O components 718 may include output components 726 and input components 728. The output components 726 may include visual components (e.g., a display such as a plasma display panel (PDP), a. light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 718 may include biometric components 730, motion components 734, environmental components 736, or position components 738 among a wide array of other components. For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 734 may include acceleration sensor components (e.g., accelerometer), gravitation sensor components, rotation sensor components (e.g., gyroscope), and so forth. The environmental components 736 may include, for example, illumination sensor components (e.g., photometer), temperature sensor components e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 738 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 732 or devices 720 via a coupling 724 and a coupling 722, respectively. For example, the communication components 740 may include a network interface component or other suitable device to interface with the network 732. In further examples, the communication components 740 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 720 may be another machine or any of a wide variety of peripheral devices (e.g., a peripheral device coupled via a USB).

Moreover, the communication components 740 may detect identifiers or include components operable to detect identifiers. For example, the communication components 740 may include :Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as location via Internet Protocol (IP) geo-location, location via Wi-Fi® signal triangulation, location via detecting an NFC beacon signal that may indicate a particular location, and so forth.

In various example embodiments, one or more portions of the network 732 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 732 or a portion of the network 732 may include a wireless or cellular network and the coupling 724 may be a Code Division Multiple Access (CDMA) connection, a Global System for Mobile communications (GSM) connection, or another type of cellular or wireless coupling. In this example, the coupling 724 may implement any of a variety of types of data transfer technology, such as Single Carrier Radio Transmission Technology (1×RTT), Evolution-Data Optimized (EVDO) technology, General Packet Radio Service (CPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed :Packet Access (HSPA), Worldwide Interoperability for Microwave Access (WiMAX) Long Term Evolution (LTE) standard, others defined by various standard-setting organizations, other long range protocols, or other data transfer technology.

The instructions 710 may be transmitted or received over the network 732 using a transmission medium via a network interface device (e.g., a network interface component included in the communication components 740) and utilizing any one of a number of well-known transfer protocols (e.g., hypertext transfer protocol (HTTP)). Similarly, the instructions 710 may be transmitted or received using a transmission medium via the coupling 722 (e.g., a peer-to-peer coupling) to the devices 720. The term “transmission medium” shall be taken to include any intangible medium that is capable of storing, encoding, or carrying the instructions 710 for execution by the machine 700, and includes digital or analog communications signals or other intangible media to facilitate communication of such software.

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable (late Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

The modules, methods, applications and so forth described herein are implemented in some embodiments in the context of a machine and an associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving, at a multi-service hub having an operating system layer and an application layer, a text message originating from a cellular device, the text message compliant with a cellular message protocol;
determining, at the multi-service hub, whether a service application request extracted from the text message is treated as a local service application request and whether the service application request extracted from the text message is treated as a remote service application request;
responsive to the service application request being treated as the remote service application request, forwarding the remote service application request from the multi-service hub to a remote service application handler; and
responsive to the service application request being treated as the local service application request, processing the local service application request at the multi-service hub with a local service application at the application layer on the multi-service hub.

2. The method of claim 1, further comprising:
extracting, at the multi-service hub, the service application request from the text message by parsing the text message for the service application request.

3. The method of claim 1, wherein the cellular m :message protocol of the text message is Short Message Service (SMS).

4. The method of claim 1, wherein the cellular message protocol of the text message is Multimedia Messaging Service (MMS).

5. The method of claim 1, wherein the local service application request complies with an application program interface of the local service application at the application layer on the multi-service hub.

6. The method of claim 1, wherein the remote service application request complies with an application program interface of a remote service application accessed by the remote service application handler.

7. The method of claim 1, wherein said determining includes:
referring to a lookup table that, for a particular type of the service application request, distinguishes between whether the particular type of the service application request is treated as the local service application request and whether the particular type of the service application request is treated as the remote service application request.

8. The method of claim 1, wherein the local service application is identified by the particular type of a service application request extracted from the text message.

9. A method comprising:
receiving, at a configuration server, a request for a configuration update of a multi-service hub, the multi-service hub having an operating system layer and an application layer; and
at the configuration server, responsive to the request for the configuration update of the multi-service hub, causing an update of a lookup table at the multi-service hub, the lookup table at the multi-service hub determining whether a service application request extracted from a text message compliant with a cellular message protocol originating from a mobile device, is treated by the multi-service hub as a local service application request processed at the application layer of the multi-service hub, and the lookup table at the multi-service hub determining whether the particular type of the service application request is treated as a remote service application request forwarded from the multi-service hub to a remote service application handler.

10. The method of claim 9, further comprising:
at the configuration server, responsive to the request, causing availability of a local service application at the application layer on the multi-service hub, such that responsive to the local service application being identified by the particular type of a service application request extracted from the text message, the local service application request is processed by the local service application at the application layer on the multi-service hub.

11. The method of claim 9, wherein the cellular message protocol of the text message is Short Message Service (SMS).

12. The method of claim 9, wherein the cellular message protocol of the text message is Multimedia Messaging Service (MMS).

13. The method of claim 9, wherein the local service application request complies with application program interface of a local service application at the application layer on the multi-service hub.

14. The method of claim 9, wherein the remote service application request complies with an application program interface of a remote service application accessed by the remote service application handler.

15. A configuration server comprising:
a storage device storing instructions; and
one or more hardware processors configured by instructions to perform operations comprising:
receiving, at the configuration server, a request for a configuration update of a multi-service hub, the multi-service hub having an operating system layer and an application layer; and
at the configuration server, responsive to the request for the configuration update of the multi-service hub, causing an update of a lookup table at the multi-service hub, the lookup table at the multi-service hub determining whether a particular type of a service application request extracted from a text message compliant with a cellular message protocol originating from a mobile device, is treated by the multi-service hub as a local service application request processed at the application layer of the multi-service hub, and the lookup table at the multi-service hub determining whether the particular type of the service application request is treated as a remote service application request forwarded from the multi-service hub to a remote service application handler.

16. The configuration server of claim 15, further comprising:
at the configuration server, responsive to the request, causing availability of a local service application at the application layer on the multi-service hub, such that responsive to the local service application being identified by the particular type of a service application request extracted from the text message, the local service application request is processed by the local service application at the application layer on the multi-service hub.

17. The configuration server of claim 15, wherein the cellular message protocol of the text message is Short Message Service (SMS).

18. The configuration server of claim 15, wherein the cellular message protocol of the text message is Multimedia Messaging Service (MMS).

19. The configuration server of claim 15, wherein the local service application request complies with an application program interface of a local service application at the application layer on the multi-service hub.

20. The configuration server of claim 15, wherein the remote service application request complies with an application program interface of a remote service application accessed by the remote service application handler.
